(19) United States
(12) Patent Application Publication
(10) Pub. No.: US 2002/0095491 A1
(43) Pub. Date: Jul. 18, 2002

(54) System and related methods for remote production line monitoring using the Web

(76) Inventors: Doug E. Edmonds, Philomath, OR (US); Gregory J. May, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/765,906

(22) Filed: Jan. 18, 2001

(51) Int. Cl. G06F 15/173

(52) U.S. Cl. 709/224

(57) ABSTRACT

In a product order, delivery, management (ODM) system, a system provides a client with remote access to current information on product orders being processed on production lines in original equipment manufacturer (OEM) partner production facilities located virtually anywhere in the world. The system also provides access to product data at OEM associated product centers, such as product refurbishment, service, and shipping centers, enabling the tracking of production failure issues and the generation and comparison of production performance parameters within and amongst client OEM partners. The system includes a host server that serves an interactive Web page over a network to a client accessing the server using a browser. The server renders the interactive Web page after receiving valid client identification. It then receives client query input via the interactive Web page. The server forms a proper query based on the client input and sends the query to remote computer databases at the OEM facilities. Computers at OEM production lines and associated product centers respond to the query by transferring query results back to the host server. The client receives the query results in the form of a Web page which has been populated with the results for viewing, or in the form of a data file which permits further processing. In addition, a master application executing on the client polls OEM production line and product center computers for data, and typically updates a local client database with the collected data. The master application can then process the data in a comprehensive manner, over various time periods and across all OEM production facilities, to provide feedback on OEM production line and product center performance for all OEM facilities, improving the overall ODM system.

### TECHNICAL FIELD

This invention generally relates to a product order, delivery, management (ODM) system and, more particularly, to a system and related methods for remotely monitoring a production line using the Web in such an ODM system.

### BACKGROUND

Economic expansion and trends in various industries toward mergers, acquisitions and spin-offs have resulted in many companies which have multiple production sites or original equipment manufacturers (OEM) scattered throughout different geographic locations, including different regions of the world. In addition, such companies often contract with various partners to have products manufactured at OEM partner facilities. These OEM partners can also be located in different regions throughout the world.

In order to remain competitive, companies have an increasing need for ODM systems that provide up to date information on the status of product orders being processed at all of their associated OEMs. As the number and remoteness of a company's OEMs increase, acquiring timely and accurate production information becomes more difficult. This is especially true where the production facilities being utilized are partner OEMs.

Low level product configuration details, such as what software version is installed on a computer coming off of a partner OEM production line, are typically not confirmed until some of these products are returned to an associated product refurbishment or service center. Generally, product refurbishment centers receive products which have not been used by customers, but which have had the packaging opened and which may have been turned on by the customers. These products are typically undamaged and need to be inspected and possibly upgraded for resale through a different outlet channel which sells them as non-new. Product service centers receive products which have been used by customers and which need to be repaired and returned to these same customers.

Because OEM production lines usually process most or all of a given product order by the time a problem is discovered in products returning to a product refurbishment or service center, it is often too late to adjust the production line to correct problems with a particular product order, and a company must incur significant rework expense at the product centers. The availability of product configuration details in real-time, or as products come off an OEM production line, permits an on-the-spot correction of such problems and reduces later rework expense.

In addition to allowing for immediate correction of product orders on the production line, the availability of original product configuration details from an OEM production line provides information on whether products have been altered prior to their arrival at product refurbishment or service centers. Such information is useful in determining whether product upgrades, such as the latest hardware or software, should be installed. Furthermore, detailed OEM production line information enables the tracking of product failures appearing at product centers back to their originating OEM. Also, since products sometimes return more than once to product refurbishment or service centers, it is useful to have access to product upgrade information on products leaving these centers as a further means of tracking products.

Therefore, monitoring and tracking product configuration details from OEM partner production lines and associated product refurbishment and service centers can help reduce the cost of reworking and upgrading products as well as provide important information regarding the performance of particular OEMs in specific areas of production. Acquiring such product configuration information from the partner OEMs themselves however is often difficult, and the information unreliable. Consequently, personal visits by company employees to OEM production lines during the processing of product orders to confirm product configuration details has been the most effective way of reducing such costs. However, as OEM partners are increasingly located throughout the world, such visits become very costly and are an inefficient use of employee time.

Accordingly, there is a need for a way to monitor remote production lines and access real-time production line information for use in ODM systems. Furthermore, the need exists for a way to monitor and track information on products returned to remote product refurbishment and service centers.

### SUMMARY

A system provides a client with remote access to current information on product orders being processed on production lines in original equipment manufacturer (OEM) partner production facilities located virtually anywhere in the world. The system also provides access to product data at associated product centers, such as refurbishment, service, and shipping centers, enabling the tracking of product issues in various areas, including product failure and distribution. Tracking product issues is facilitated through the generation and comparison of production performance and product distribution parameters within and amongst client OEM partners.

The system includes a host server that serves an interactive Web page over a network to a client accessing the server using a browser. The server renders the interactive Web page after receiving valid client identification. The server receives client input via the interactive Web page regarding product orders processed on an OEM partner production line. The server forms a query based on the client input and sends the query over a network to the appropriate OEM production line computer which is configured to continually monitor the production line of interest and update a database. The OEM computer responds to the query by transferring query results back to the host server. The client receives the query results in the form of a Web page which has been populated with the results for viewing, or in the form of a data file which permits further processing.

Product centers, such as refurbishment, service, and shipping centers, provide various product-oriented functions. Product centers are typically associated with a particular OEM, and may be located at the OEM facility or may be remotely located. A refurbishment computer is configured to monitor products being returned to the product refurbishment center which generally have not been used by customers, but which may have had the packaging opened and may have been turned on by a customer. The computer updates a database with information on the returned products, including information on product failures and any product upgrades made before the product is sent out for resale. A service computer is configured to monitor products which typically have been used by customers and are being returned to the product service center for repair. The computer updates a database with product failure and repair information before the product is sent back to the customer. Similarly, computers at various additional product centers, such as shipping and distribution centers, collect product data related to the product center function and update their respective databases.

The product center computers also receive and respond to product data queries related to the product center function. The queries originate with a client and come through the host server based on client input to an interactive Web page. They are received over a network either through an associated OEM production line computer or directly from the host server.

In addition to running a browser, a client executing a master application can poll OEM production line and product center computer databases linked to the network to gather up to date product information which the master application uses to generate and compare production performance metrics across OEM partners. Typically, a client updates a local or master database during polling sessions so that product information from each OEM production line and product center (e.g., refurbishment center, service center, shipping center) is available and accurate up to the most recent polling session. Accruing data over time in a local/master client database permits the generation and comparison of production performance metrics within a particular OEM across time periods, such as from month to month, in addition to providing such metrics for comparison across numerous OEM partners. In the event a network link is lost, thereby preventing a current polling session with a particular OEM or product center, the local client database provides accurate data up to the most recent polling session with the unlinked OEM or product center, allowing the master application to include the unlinked OEM or center in generating and comparing production metrics across all OEMs.

A client executing a master application can additionally distribute production performance and product distribution metrics across the system to the various OEM production lines and product centers. Metrics viewing sessions at these facilities assists each facility in knowing areas of performance which need improvement and how each facility compares to other OEM partner facilities.

### BRIEF DESCRIPTION OF THE DRAWINGS

FIG. 1 shows a production line monitoring system having a host server that serves an interactive Web page to a client and facilitates the transfer of data between a client and an OEM production line and its associated refurbishment and service centers via a network, such as the Internet.

FIG. 2 illustrates an example interactive Web page as might appear on a client monitor enabling a user to enter query information about a product order and view query results showing the status of the product order at the production line.

FIG. 3 is a block diagram of an exemplary production line monitoring computer, an exemplary refurbishment center monitoring computer, and an exemplary service center monitoring computer that may be used in the production line monitoring system.

FIG. 4 illustrates a sample database table representing production line data that might be stored in a production line database.

FIG. 5 illustrates a sample query output table representing results of a query generated from user input to an interactive Web page.

FIG. 6 illustrates an additional example of an interactive Web page showing query output results which exemplify a production line monitoring system used to monitor production facilities processing notebook computers.

FIG. 7 illustrates two performance metrics viewing sessions indicating percentages of production failures with respect to product failures at first turn-on and product failures at a customer.

FIG. 8 illustrates two performance metrics viewing sessions indicating product shipping performance for a North American and European shipping center compared to the average shipping performance for all shipping centers.

FIG. 9 is a flow diagram of a process for remotely monitoring a production line and its associated product centers via a network.

FIG. 10 is a flow diagram of a process for generating and comparing performance metrics, and for transferring performance metrics back to OEM production facilities and product centers throughout the monitoring system.

### DETAILED DESCRIPTION

### Exemplary Internet-Based Production Line Monitoring System

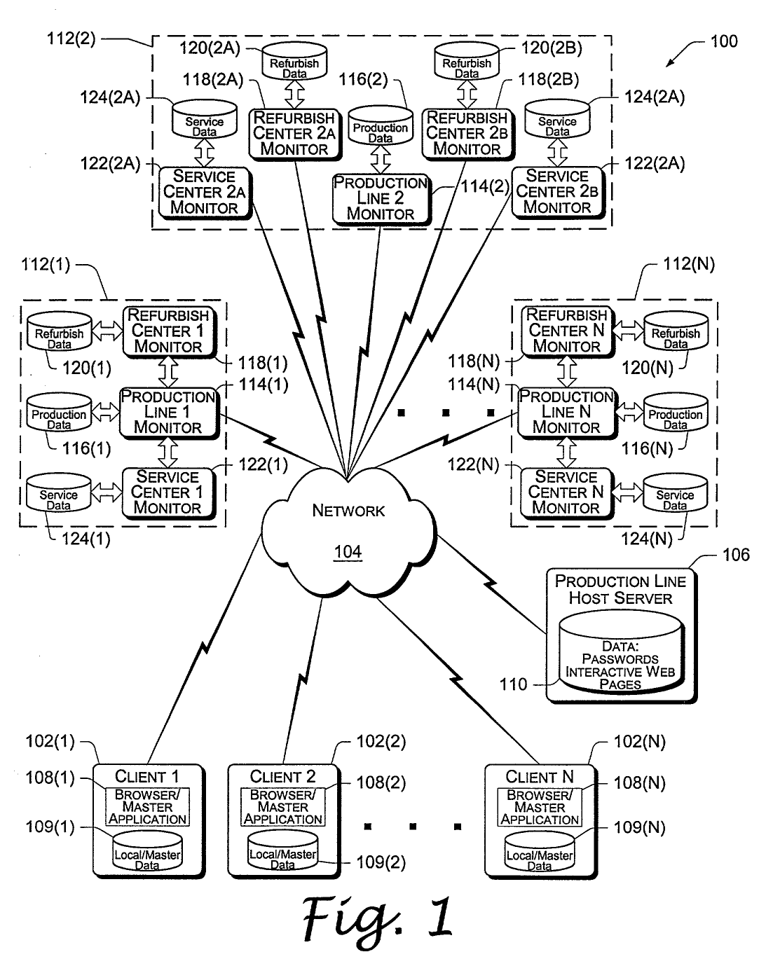

FIG. 1 illustrates an exemplary production line monitoring system 100 that allows a client 102 to remotely access production line information via a network 104. The system 100 is well suited, but not limited, to operating in a production environment where numerous original equipment manufacturer (OEM) production lines operate remotely. While the system 100 can be implemented using other networks (e.g. a wide area network) and should not be limited to the Internet, the system 100 will be described in the context of the Internet as one suitable network implementation.

The production line monitoring system 100 has a host server 106 that forms a Web site on the Internet 104. The host server 106 is configured to serve Web pages containing services and information to clients 102 accessing the host server 106 while running a Web browser 108. Clients 102 include general purpose computing devices such as desk top and lap top computers and mobile hand held information devices. These devices typically have one or more processors, a memory, and input/output devices such as a keyboard, a mouse, a monitor, a printer, and speakers. Client 102 memories in the exemplary system 100 have a number of stored program modules including a Web browser and master application 108 in addition to a local or master database 109. The host server 106 is further configured to ensure users are authorized to access data by checking for valid client identification. Clients 102 receive a data entry form only after providing valid identification. The data entry form is preferably in the form of an interactive Web page. Although the system 100 currently provides a client password identification system, other validation security check systems are contemplated, such as biometrics identification systems. Client identification account information and Web pages stored on the host server database 110 can be periodically updated.

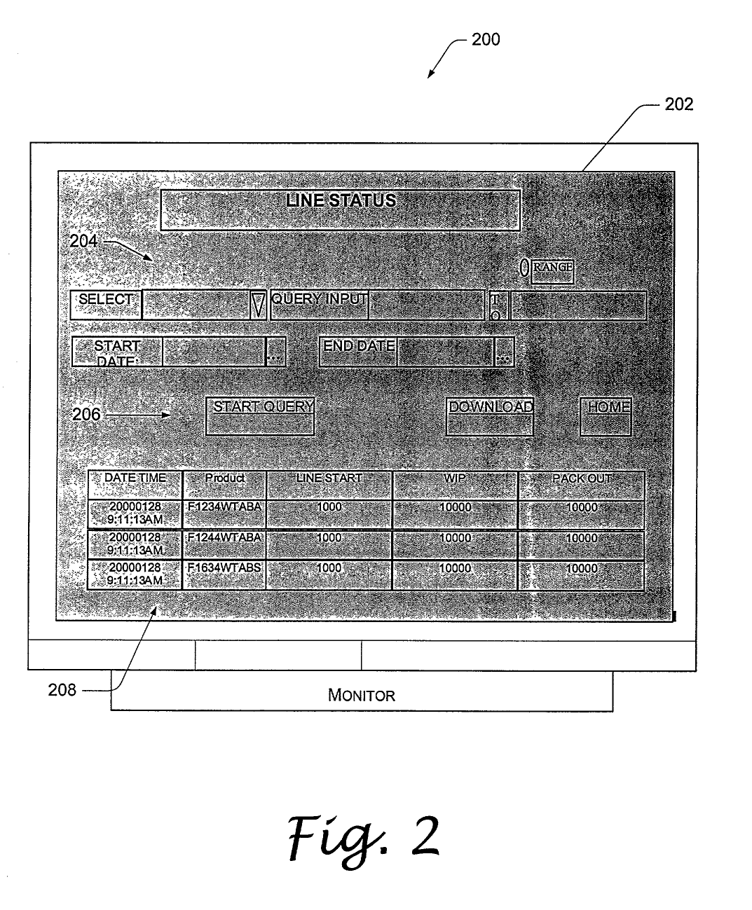

Referring now to FIG. 2, an interactive Web page and its role within the production line monitoring system 100 will be described. FIG. 2 illustrates a client monitor 200 displaying an example of an interactive Web page 202. The sample interactive Web page 202 displays an area toward the upper part of the page where a user provides query input information 204. For example, the ‘Select’ box allows a user to select production line information by identifiers such as product family names, product platforms, model numbers, or stock numbers. The ‘Query Input’ and ‘To’ boxes allow a user to define a range of selected information, such as a range of model numbers. The ‘Start Date’ and ‘End Date’ boxes permit the user to define a desired date range for the selected information.

In the center of the sample interactive Web page 202 are command functions 206 which a user can activate. The command functions 206 illustrated in the sample page 202 include a ‘Start Query’ function, which begins a process for executing a query based on the query input information 204 provided by a user. The ‘Download’ function begins downloading query results in a spreadsheet (e.g., XCEL) format to the client 102. The ‘Home’ function returns a user to the home Web page initially provided by the host server 106.

Finally, toward the bottom of the interactive Web page 202 is the query output area 208, where query results are displayed. The query output area 208 displays a snapshot of a production line at a point in time, thereby presenting currently available production line information regarding the specific query input information 204 provided by a user.

It is noted that the interactive Web page 202 shown in FIG. 2 is only an example interactive Web page. The present invention contemplates a number of interactive Web pages of various types, such that an actual interactive Web page may vary in layout, look and feel, and may provide functionality beyond the basic functionality presented by the example interactive Web page 202 of FIG. 2. For example, additional functions (not shown) for which an interactive Web page 202 would permit user input include, polling network databases (e.g., OEM production line databases 116, refurbishment databases 120, and service databases 124, from FIG. 1) for up to date product information, and placing a product order to a production line.

Returning now to FIG. 1, OEM production lines typically have associated product centers, such as refurbishment, service, and shipping or distribution centers. These product centers may be collocated within an OEM production facility 112 (e.g., 112(1) and 112(N) of FIG. 1), such that communications between the product centers and the production line flow along an internal network, such as a local area network (LAN). The product centers may also be remotely located as illustrated by OEM production facility 112(2), in which case communications between the centers and the production line may flow across the network 104. For the purpose of discussion, FIG. 1 illustrates OEM production lines with associated product centers grouped together as OEM production facilities 112. Although these OEM facilities 112 are typically functionally arranged in this manner, they are not limited to this arrangement, and the present invention contemplates a system 100 in which additional product centers, such as distribution and sales centers, are part of OEM production facilities 112. In addition, the present invention contemplates a system 100 in which product centers interact with OEM production lines with which they are not necessarily associated. For example, production line 1 monitor 114(1) may also interact with service center 2A monitor 122(2A).

In the exemplary system 100 of FIG. 1, the host server 106 is configured to receive query input information 204 from the client 102 as entered into the interactive Web page 202, and to form an SQL query based on this information. The host server 106 transfers the query to the appropriate location, which may be any OEM production line monitor 114, refurbishment center monitor 118, or service center monitor 122 and their respective databases 116, 120, and 124. As mentioned above, additional product centers such as distribution and sales centers (not shown in FIG. 1) may also be a part of an OEM production facility 112, and thus would also have product center monitors and databases to which the host server 106 might direct product queries. Databases in the present invention include standard relational databases where various data manipulation languages, such as SQL (structured query language), are used to extract data from a database.

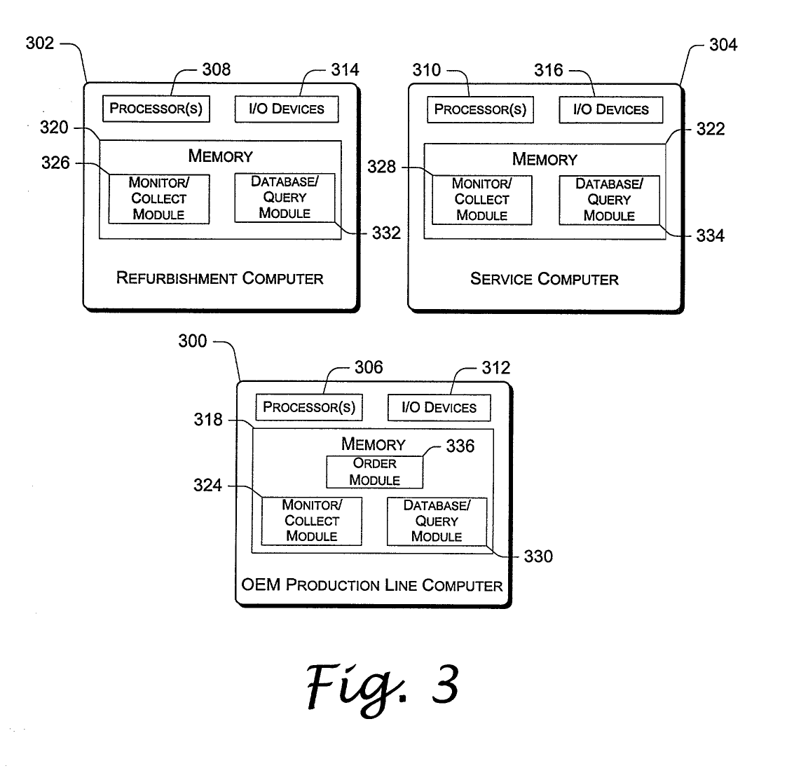

OEM production line monitors 114, refurbishment center monitors 118, and service center monitors 122 include respective computers 300, 302, and 304, as illustrated in FIG. 3. Note that additional product centers such as distribution and sales centers (not shown in FIG. 1) would have similarly configured product center monitors. The OEM production line computer 300, refurbishment computer 302, and service computer 304, include respectively, one or more processors 306, 308, and 310, input/output devices 312, 314, and 316, and memories 318, 320, and 322. Typical input devices (not shown) include those suitable to the task of inputting information into the OEM computer 300, the refurbishment computer 302, and the service computer 304, such as a keyboard, a mouse, and a camera. Similarly, typical output devices (not shown) may include a monitor, a printer, and speakers.

A number of program modules are stored in the OEM computer memory 318, the refurbishment computer memory 320, and the service computer memory 322, including respectively, monitor/collect modules 324, 326, and 328, and database/query modules 330, 332, and 334. The monitor/collect module 324 executes on processor(s) 306, directing OEM production line computer 300 to continually monitor the production line and collect product data on all the product orders processed on the production line. The database/query module 330 executes on processor(s) 306 directing OEM computer 300 to store the product data into the production database 116 and respond to queries received from the host server 106.

Similarly, in the refurbishment computer 302, the monitor/collect module 326 executes on processor(s) 308, directing the refurbishment computer 302 to continually monitor and collect data on products that are returned to the refurbishment center and products that are upgraded at the center. The database/query module 332 executes on processor(s) 308 and directs the refurbishment computer 302 to continually store this data into the refurbish database 120 and respond to queries. The monitor/collect module 328 in the service computer memory 322 executes on processor(s) 310, directing the service computer 304 to monitor and collect data on products returned to the service center. The database/query module 334 directs the service computer 304 to store the data in the service database 124 and respond to related queries from the host server 106. Data typically collected and stored at product centers includes but is not limited to product configuration data, product identification and tracking data, product failure data, product servicing and upgrade data, and product shipping and distribution data.

In addition to the monitor/collect and database/query program modules which are common among the computer memories 318, 320, and 322, the OEM production line computer memory 318 additionally has an order module 336 which executes on processor(s) 306 to process a product order received from the host server 106. In the event that product order information has been entered on an interactive Web page 202, the order module 336 directs the computer 300 to respond with an order confirmation and enter the order on the production line.

Returning again to FIG. 1, the host server 106 is configured to receive query results from the OEM computer 300 and product center computers, such as the refurbishment computer 302 and the service computer 304. The host server 106 then either populates an interactive Web page 202 with the query results and serves the Web page 202 to a client 102, or downloads the results to the client 102 in a spreadsheet or similar data file format which permits processing the results.

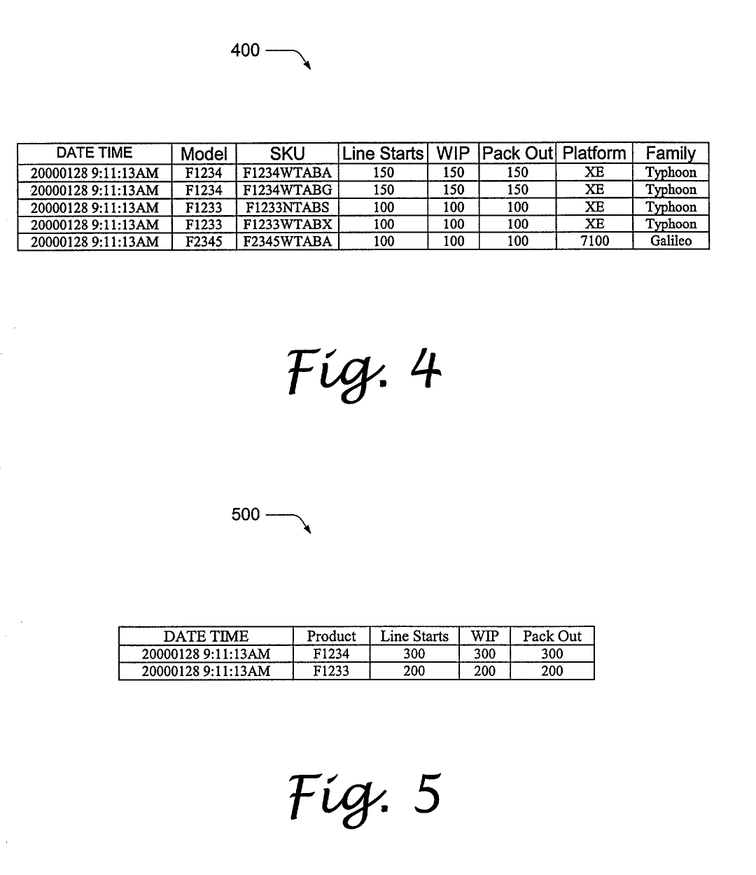

Use of the interactive Web page 202 to retrieve production line information is demonstrated in a simple example with reference to FIGS. 4 and 5. FIGS. 4 and 5 illustrate respectively, a sample database table 400 representing production line data that might be stored in a production database 116 as shown in FIG. 1, and a sample query output table 500 which displays results of a query generated based on user input information 204 to an interactive Web page 202. The ‘Date Time’ columns common to both tables 400 and 500 represent the date and time of the most recent update of production line information to the production database 116. The ‘Line Starts’ columns represent the number of units started on the production line. The ‘WIP’ (work in progress) columns represent units that have been started on the production line but not yet completed, and the ‘Pack Out’ columns represent units that are ready for shipping from a pack-out station. In addition to the columns which are common to both tables, the sample database table 400 includes a ‘Model’ column representing unit models, an ‘SKU’ (stock keeping unit) column representing a more detailed stock number for each model, a ‘Platform’ column representing product platforms within families of products, and a ‘Family’ column representing the product families. The sample query output table 500 additionally includes a ‘Product’ column which represents the actual products selected from the database table 400 when the query executes.

Assuming the sample database table 400 of FIG. 4 is the sum of all production line data stored in a production database 116, the sample query output table 500 of FIG. 5 can be generated with several different user inputs 204 to the interactive Web page 202. For example, selecting ‘Family’ in the ‘Select’ box (this inactivates the ‘Range’ selection) and entering ‘Typhoon’ in the ‘Query Input’ box, results in the query output table 500. The ‘Product’ column in the query output table 500 indicates that all available products from the ‘Typhoon’ family currently in the database table 400 are included in the query output table 500 and listed by their model number. Status columns such as ‘Line Starts’, ‘WIP’, and ‘Pack Out’, show lump sums of each model variation. Another set of user inputs that will generate the same query output table 500 includes selecting ‘Model’ in the ‘Selection’ box with ‘F1234’ in the ‘Query Input’ box and ‘F1233’ in the ‘To’ box (the ‘Range’ selection is active). The query output table 500 includes the range of models specified by the query input.

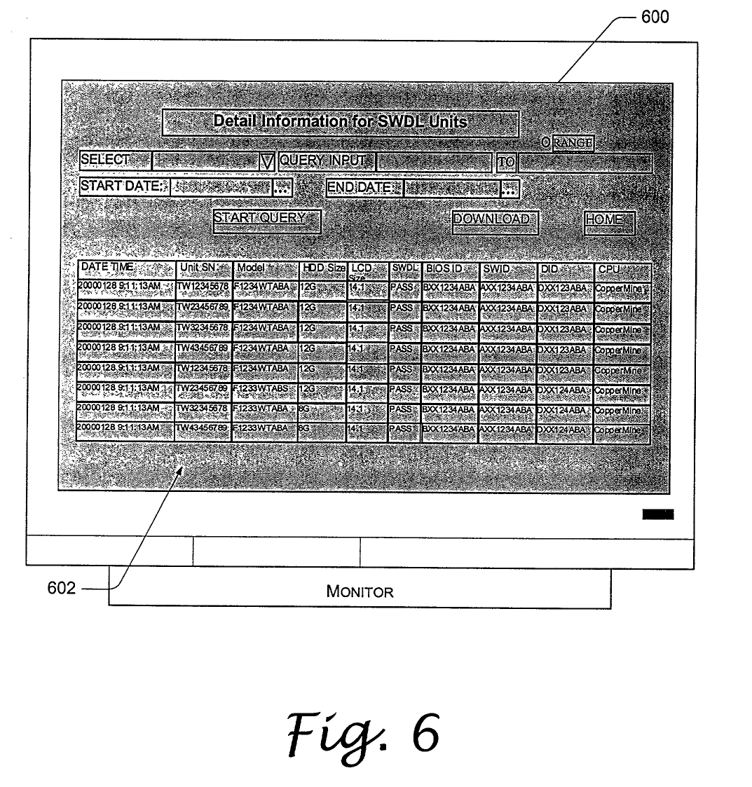

In a more realistic example, the system 100 of FIG. 1 is likely to include a production database 116 containing data far more extensive than that indicated by the sample database table 400 of FIG. 4. For instance, FIG. 6 shows another example of an interactive Web page 600 with query output results 602 that are exemplary of a system 100 which is used to monitor production facilities processing notebook computers. In this production environment, the system 100 provides a user with access to up to date production information including hard disk drive (HDD) size, liquid crystal display (LCD) size, software identification (SWID), and CPU type.

In general, the query results as described above can offer an even greater benefit when further processed to provide important information about an OEM's production performance. For instance, the query results can determine information such as the number of units with a particular configuration, the length of time it takes from product order to product use, the number of times particular units are upgraded, and whether the configuration of a unit returned to a product refurbishment or service center matches its original configuration when it left the OEM production line. Such further processing of query results can take place within the system 100 prior to transferring the query results to the client 102 or it may occur at the client 102.

However, where numerous OEM facilities 112 are part of a system 100, processing query results and general product data gathered from various OEM facilities 112 offers significant additional advantages by providing important information about vital questions integrally related to the overall ODM system purpose. An important aspect of the exemplary system 100 of FIG. 1 is thus the inclusion of a master application in addition to a browser 108 which executes on a client 102 to take full advantage of the product data made available through the network-linked system 100. The master application 108 executes on a client 102 to poll OEM facility 112 databases (i.e., OEM production line databases 116, refurbish databases 120, service databases 124, and other product center databases) for the latest product data updates to each database. The master application 108 then typically updates a local or master client database 109 with the collected data. The master application 108 can then process the data in a comprehensive manner and provide valuable feedback to a client and to OEM production lines and product centers regarding performance in all product areas including production, shipping and distribution, sales, service, and the like.

The advantages of such a comprehensive system 100 include the ability to generate and compare production performance and product distribution metrics across numerous OEMs over long time periods. One example is in the area of tracking product failure issues. Product identification and tracking data gathered from service databases 124 on failed products returned to service centers includes product serial numbers and “born-on” dates. The master application 108 processes serial numbers, tracking them back to a particular OEM, a particular production line within the OEM, a particular production week, a particular production shift crew, and so on. Born-on dates are the actual dates a customer first loads software to begin the warranty process. When serial numbers are linked with born-on dates, they indicate the amount of time it takes a particular product to fail from the day it began functioning. Although a serial number alone will indicate the day a product came off an OEM production line, it will not indicate the amount of time the product has been in use, because shipping time and shelf time may not be known. Thus, without using born-on dates, it is impossible to determine a product's “time to failure”, or how long a product was in use prior to failing. The master application 108 can quickly generate information on product failure issues and normalize it to a “product time to failure” across numerous OEMs. Thus, numerous OEMs can be compared across various product types to determine how well their production processes measure up to each other and to industry standards. In addition, production performance metrics of new OEMs brought on-line in the system 100 can be compared to current OEM metrics through the historical data in the local/master client database 109. Such comparisons can assist ODM system managers in determining where best to allocate vital resources. The information additionally provides invaluable feedback to OEMs regarding their production processes and their need for improvement in particular areas.

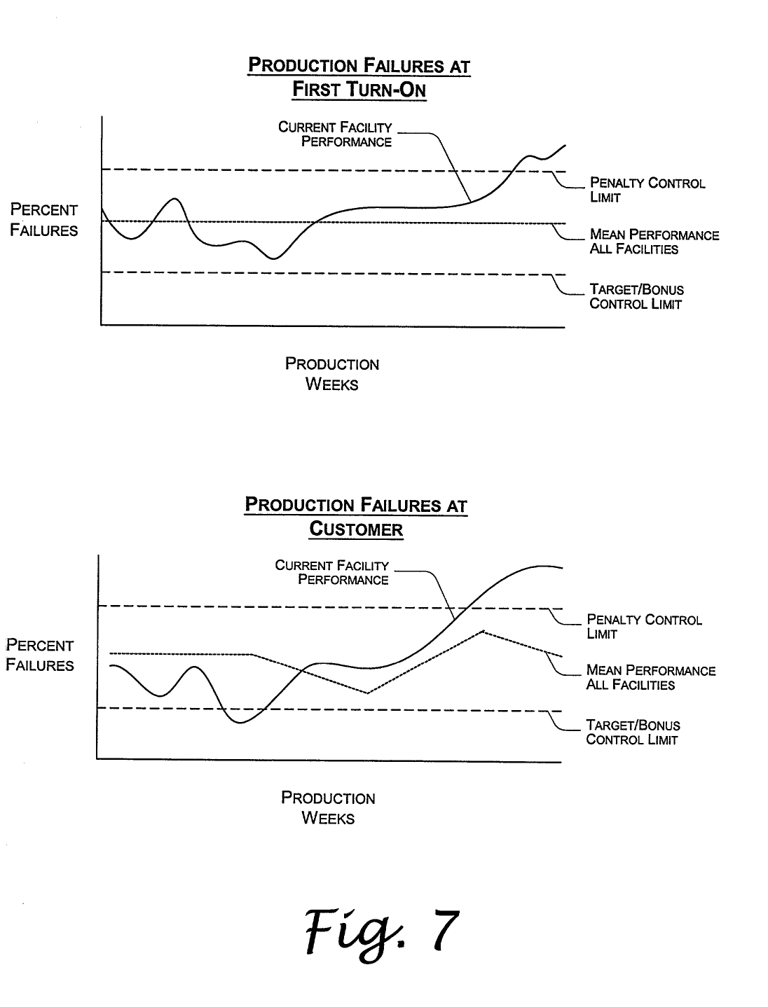

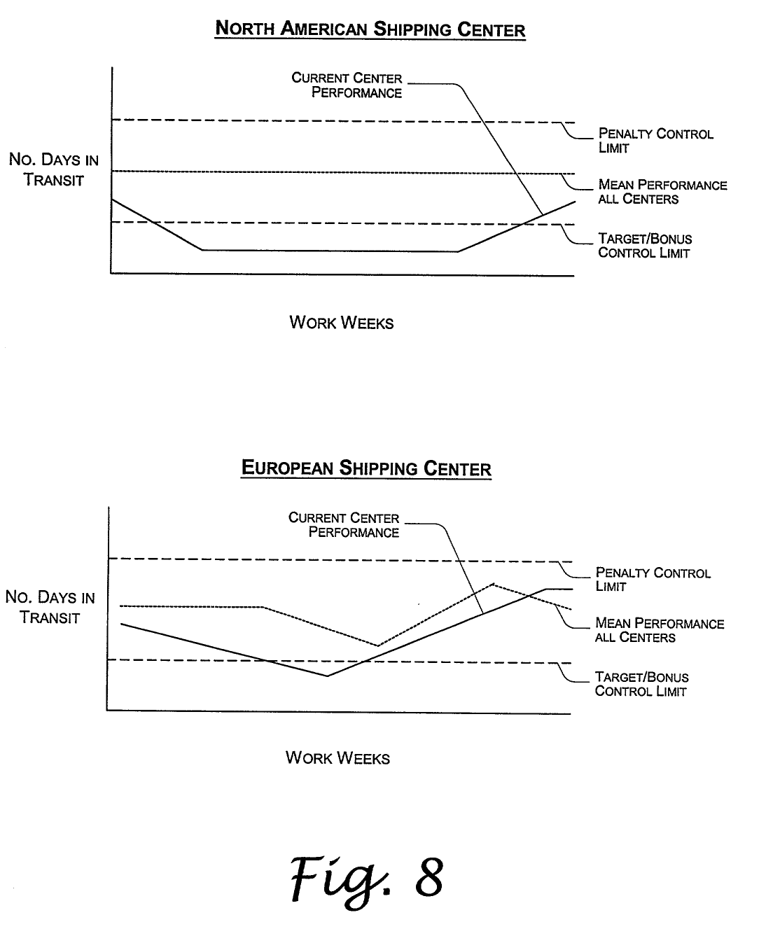

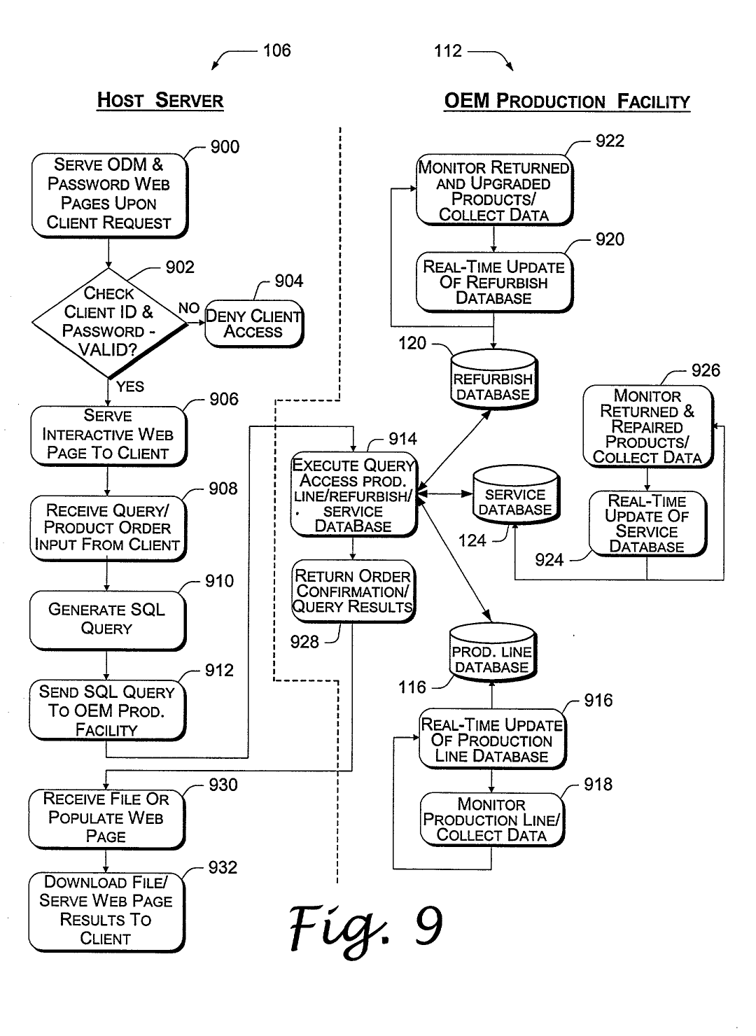

Examples of metrics viewing sessions showing production performance and product distribution metrics which might be generated by the master application 108 are illustrated in FIGS. 7 and 8. These metrics viewing sessions are available to a client 102 and to any production facility or product center. FIG. 7 shows two viewing sessions indicating percentages of production failures. The ‘PRODUCTION FAILURES AT FIRST TURN-ON’ viewing session shows a current production facility's percentage of product failures when the products are first turned on, compared to the average percentage of these failures for all OEM production facilities in the system 100. Although viewing sessions in general can offer a variety of performance metrics information, the examples in FIG. 7 both include upper and lower performance control limits. The ‘PENALTY CONTROL LIMIT’ informs both the client 102 and the production facility the performance level at which a penalty will apply because the percentage of product failures is too high. Likewise, the ‘TARGET/BONUS CONTROL LIMIT’ indicates the performance level at which a bonus will apply because the percentage of product failures is kept low. The ‘PRODUCTION FAILURES AT CUSTOMER’ viewing session shows a current production facility's percentage of product failures occurring at a customer, compared to the average percentage of these failures for all OEM production facilities. In general, this information tells a client 102 how well each OEM production facility 112 is performing with respect to all other facilities. The client 102 executing the master application 108 can also transfer performance metrics to each production facility and product center, making available similar viewing sessions at these locations.

In FIG. 8, examples of metrics viewing sessions showing product shipping performance are illustrated. The ‘NORTH AMERICAN SHIPPING CENTER’ viewing session shows a current North American shipping center's performance compared to the average performance of all the OEM shipping centers in the system 100, along with penalty and bonus control limits. Similarly, the ‘EUROPEAN SHIPPING CENTER’ viewing session shows a current European shipping center's performance compared to the average performance of all the OEM shipping centers in the system 100. This information tells a client 102 how well its shipping centers throughout the world deliver products. In addition, these performance metrics can be transferred over the network 104 to the shipping centers, informing them how they are performing on average against the other OEM shipping centers.

It is noted that the master application 108 can additionally process polled data from OEM facility 112 databases without storing the data on a local/master client database 109. A local/master client database 109 is therefore not a necessary feature of a system 100 operating in this manner. However, a system 100 configured without a local/master client database 109 permits the generation and comparison of production metrics only as far back as the individual OEM facility 112 databases store data. Since the individual OEM facility 112 databases may vary in size and length of data storage time, a system 100 configured without a local/master client database 109 offers considerably less to the overall ODM system, as the ability to compare production metrics over time may be significantly reduced.

### Exemplary Method of Operation for Production Line Monitoring System

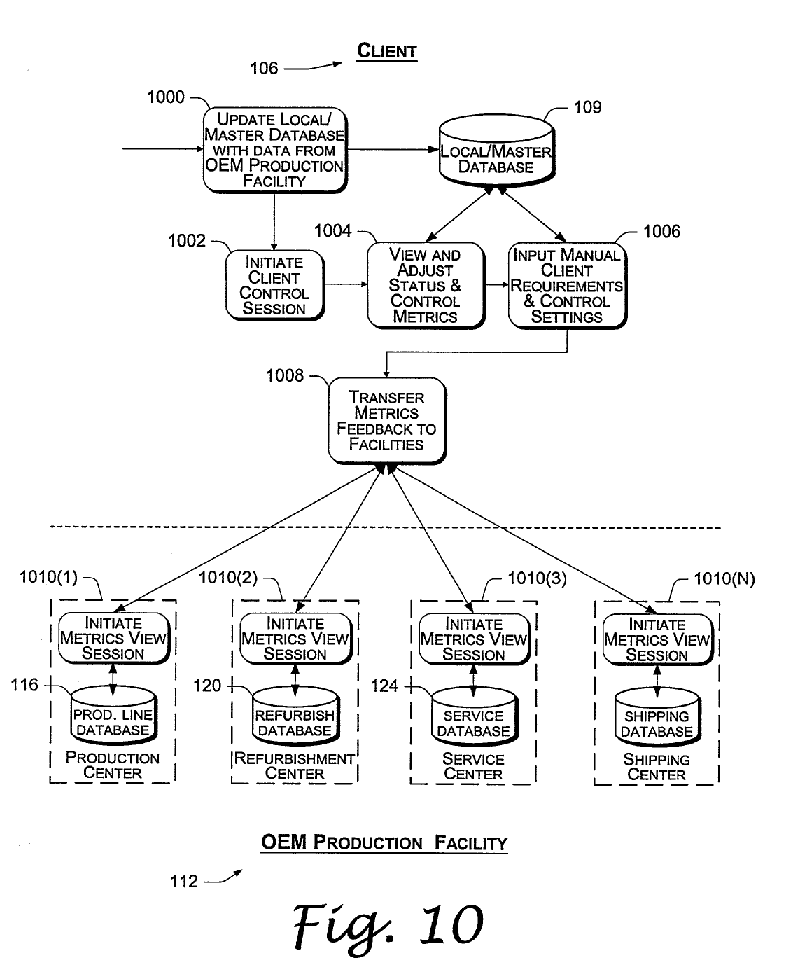

Having introduced the production line monitoring system 100, an example method of operation will be presented with primary reference to FIGS. 9 and 10. FIG. 9 is a flowchart illustrating the general operation of the production line monitoring system 100. Operation of the system 100 passes back and forth between the host server 106 and the OEM production facility 112. Although the system 100 is continually collecting production data at OEM facilities 112 and updating databases (e.g., databases 116, 120, and 124, or databases at additional product centers), the process of remotely monitoring and tracking a production line and associated product centers begins when the host server 106 responds to an initial client request for access to ODM (order, delivery, management) system information, as shown in operation 900. A user directs a client 102 running a Web browser 108 to access the Web site of the host server 106. The client 102 may additionally be executing a master application 108 which directs the client browser to the host web site for polling OEM facility 112 databases. Operation 900 then begins with the host server 106 serving an initial home Web page to the client 102. The initial home Web page allows the client 102 to select an appropriate ODM Service Web page, which in turn offers the client 102 various service and support choices. After the client 102 makes a service and support selection, the host server 106 concludes operation 900 by serving a password Web page which prompts the client 102 for identification and password information.

Client 102 selection and identification responses may be provided by a user or a master application 108 executing on the client 102.

At operation 902, the host server 106 checks the client 102 identification and password against a password account stored in its database 110 and serves an interactive Web page to the client 102 in operation 906 if the identification and password are valid. The host server 106 denies access to the interactive Web page in operation 904 if the identification and password are not valid. It is noted that the system 100 of the present invention is not limited to the use of a password validation security check, but that other validation security check systems, such as a biometrics system, are additionally contemplated.

The host server 106 receives query input information from the client 102 at operation 908. The query input information can be polling information provided by the master application 108 executing on the client 102, or it may be more specific query information or order information entered into the interactive Web page by a user who begins the query by selecting a ‘Start Query’ function, as previously described with reference to FIG. 2. The host server 106 then generates a data manipulation language (DML) query, such as an SQL query 910, based on the client query input. In operation 912, the host server 106 sends the query to the appropriate OEM production facility 112.

The process of remotely monitoring and tracking a production line and associated product centers then shifts from the host server 106 to an OEM production facility 112 where the query is executed and the appropriate database (e.g., databases 116, 120, and 124, or databases at additional product centers) is accessed in operation 914. As previously discussed with reference to FIG. 3, an OEM production computer 300 is continually monitoring a production line and storing product data into a database 116. These actions are illustrated in FIG. 9 as operations 116, 916, and 918. In addition, a refurbishment computer 302 is continually monitoring and collecting data on products returned to a product refurbishment center. This data, as well as data on all product upgrades taking place at the product center, is stored in a refurbish database 120 as illustrated in operations 120, 920, and 922. A service computer 304 is continually monitoring and collecting data on products returned to a product service center. This data, as well as data on all product repairs taking place at the product center, is stored in a service database 120 as illustrated in operations 124, 924, and 926. Similarly, computers at other product centers (e.g., distribution, shipping, and sales centers, not shown) are continually monitoring and collecting data on products related to the respective product center function. In operation 914, computers 300, 302, and 304 execute queries directed to their respective databases and access appropriate data. The query results are then returned to the host server 106 in operation 928.

The process then shifts back to the host server 106, which in operation 930 receives the query results from the OEM production facility 112 in the form of a spreadsheet file or as raw data. Raw data is used to populate the interactive Web page for viewing, or it is used to update the local/master client database 109. The host server 106 then serves the populated interactive Web page to the client 102 and downloads the spreadsheet file to the client 102 if a user has selected the ‘Download’ function as previously discussed with respect to FIG. 2.

The process then continues as illustrated in FIG. 10, which is an example method of operation illustrating how the master application 108 executing on the client 102, generates and views performance metrics. These metrics are transferred to OEM production facilities and product centers throughout the system 100. At the first operation, 1000, the client updates the local/master database 109 with the query results or polling results information gathered by the process illustrated in FIG. 9. A client control session is initiated at operation 1002. The client control session permits viewing and adjusting the status of the metrics at operation 1004, and additional client requirements and control settings can be input at operation 1006. The performance metrics summarize and compare various performance parameters for all the facilities and centers within the monitoring system 100. The metrics are then transferred back out to OEM production facilities and respective product centers (e.g., production center 1010(1), refurbishment center 1010(2), service center 1010(3), shipping center 1010(N)) where they are included in metrics viewing sessions at each location.

What is claimed is:

1. A production line monitoring method comprising:
monitoring one or more production lines to ascertain product information related to one or more product orders processed on the one or more production lines;
maintaining product information in a computer-accessible database;
receiving a data request for product information;
generating a query pertaining to the data request;
sending the query to the computer-accessible database; and
receiving query results from the computer-accessible database.

2. The production line monitoring method of claim 1, wherein monitoring further comprises:
monitoring one or more product centers to ascertain product information related to a product center function.

3. The production line monitoring method of claim 2, wherein a product center function includes but is not limited to product refurbishment, product service, product shipping, product distribution, and product sales.

4. The production line monitoring method of claim 1, wherein receiving query results further comprises:
populating an interactive Web page with the query results; and
serving the populated interactive Web page to a client.

5. The production line monitoring method of claim 1, wherein receiving query results further comprises downloading the query results to a client in a data file format which permits updating a database and processing with a computer.

6. The production line monitoring method of claim 1, wherein receiving a data request further comprises serving a data entry form to a client, the method further comprising:
validating client identification prior to serving the data entry form;
permitting client access to the data entry form when the client identification is valid;
denying client access to the data entry form when the client identification is invalid; and
periodically prompting the client to renew client identification information.

7. The production line monitoring method of claim 1 further comprising:
sending a product order from the client to a production line; and
receiving a product order confirmation at the client in response to the product order.

8. The production line monitoring method of claim 2 further comprising:
updating a local database with query results;
generating product information metrics comparing production line performance and product center performance; and
transferring the product information metrics to the one or more production lines and the one or more product centers.

9. The production line monitoring method of claim 2, wherein one or more product centers are associated with and collocated with a production line.

10. The production line monitoring method of claim 2, wherein one or more product centers are associated with and remote from a production line.

11. The production line monitoring method of claim 2, wherein one or more product centers are associated with one or more production lines.

12. A computer comprising:
one or more processors;
a memory associated with the one or more processors;
a collection module stored in the memory and executable on the one or more processors to monitor a production line and collect data from the production line related to one or more product orders processed on the production line; and
a query module stored in the memory and executable on the one or more processors to receive a query for data pertaining to the production line from a host server, process the query, and transfer query results back to the host server.

13. A computer as recited in claim 12, wherein the query module is configured to transfer the query results to the host server in a format permitting the host server to populate an interactive Web page with the query results and serve the populated interactive Web page to a client.

14. A computer as recited in claim 12, wherein the query module is configured to transfer the query results to the host server in a data file format which is downloadable to a client and which permits a client computer to update a database and process the query results.

15. A computer as recited in claim 12, further comprising an order module stored in the memory and executable on the one or more processors to receive a product order and respond to the product order with a product order confirmation.

16. A computer comprising:
one or more processors;
a memory associated with the one or more processors;
a collection module stored in the memory and executable on the one or more processors to collect data pertaining to a product function performed at a product center and maintain the data in a computer-accessible database; and
a query module stored in the memory and executable on the one or more processors to receive a query from a host server pertaining to the data, process the query, and transfer query results back to the host server.

17. A computer as recited in claim 16, wherein a product function includes but is not limited to product refurbishment, product service, product shipping, product distribution, and product sales.

18. A computer as recited in claim 16, wherein the query module is configured to transfer the query results to the host server in a format permitting the host server to populate an interactive Web page with the query results and serve the populated interactive Web page to a client.

19. A computer as recited in claim 16, wherein the query module is configured to transfer the query results to the host server in a data file format which is downloadable to a client and which permits a client computer to update a database and process the query results.

20. A computer as recited in claim 16, wherein the query module is configured to receive the query from the host server through a production line computer and transfer query results back to the host server through the production line computer.

21. A computer comprising:
one or more processors;
a memory associated with the one or more processors;
a master module stored in the memory and executable on the one or more processors to log on to a host server and poll one or more computer databases for data, the databases residing at one or more remote product locations;
the master module further executable to receive and process the data, generating product information metrics comparing production line performance and product center performance;
the master module further executable to transfer the product information metrics to one or more production lines and one or more product centers.

22. A computer as recited in claim 21, further comprising a database module stored in the memory, the master module further executable to store the data in the database module each time the master module logs on to the host server and polls the one or more computer databases.

23. One or more computer-readable media containing computer-executable instructions which, when executed, direct a computer device to:
monitor a production line;
collect data related to one or more product orders processed on the production line;
receive a query pertaining to the data from a host server, the query derived by the host server from query information entered into an interactive Web page by a client, the interactive Web page provided to the client by the host server; and
transfer query results back to the host server in response to the query.

24. One or more computer-readable media as recited in claim 23, wherein the query results are in a raw data format and the host server populates the interactive Web page with the query results and serves the populated interactive Web page to the client.

25. One or more computer-readable media as recited in claim 23, wherein the query results are downloaded to the client by the host server in a data file format which permits processing the query results with a computer.

26. One or more computer-readable media as recited in claim 23, wherein the computer-executable instructions further direct a computer device to:
sort the data by identifying factors which include but are not limited to vendor, product type, order number, model number, serial number and combinations thereof; and
maintain a real-time updated record of the data in a computer-accessible database.

27. One or more computer-readable media as recited in claim 23, wherein the computer-executable instructions further direct a computer device to:
receive a product order from the client through the host server; and
respond to the product order with a product order confirmation to the client.

28. One or more computer-readable media as recited in claim 23, wherein the production line includes one or more product centers and the data includes data pertaining to product functions performed at the one or more product centers, whereby the query results comprise data pertaining to product functions performed at the one or more product centers.

29. One or more computer-readable media as recited in claim 28, wherein the production line and the one or more product centers are collocated.

30. One or more computer-readable media as recited in claim 28, wherein the production line and the one or more product centers are remote from one another.

31. A system, comprising:
a host server configured to serve a data entry form to a client and form a query based on information entered into the data entry form at the client;
one or more partner computers configured to monitor one or more production lines, collect data from the one or more production lines related to one or more product orders processed on the one or more production lines, and transfer query results to the host server in response to the query;
one or more product center computers configured to monitor products at one or more product centers, collect data related to a product center function, and transfer query results to the host server in response to the query, a product center function including product refurbishment, product service, product shipping, product distribution, and product sales;
the host server being further configured to send the query to one or more of the computers and receive the query results and present the query results to the client;
the client being configured to update a local database and process the query results, generating product information metrics comparing production line performance and product center performance;
the client being further configured to transfer the product information metrics to the one or more production lines and the one or more product centers.
